(19) United States
(12) Patent Application Publication
(10) Pub. No.: US 2011/0192212 A1
(43) Pub. Date: Aug. 11, 2011

(54) SYSTEM AND METHOD OF COUNTING AND ANALYZING ANIMAL IMPACTS ON A WIND TURBINE BLADE

(75) Inventors: Bertrand Delprat, La Montagne (FR); Gustavo Alcuri-Arnelli, Paris (FR)

(73) Assignee: ENERIA, Montlhery (FR)

(21) Appl. No.: 13/123,367

(22) PCT Filed: Oct. 9, 2009
(86) PCT No.: PCT/EP2009/063190

§ 371 Date: Apr. 8, 2011

(30) Foreign Application Priority Data
Oct. 10, 2008 (FR) 0856888

(51) Int. Cl. G01N 3/30

(52) U.S. Cl. 73/12.01

(57) ABSTRACT

System (2) for counting and analyzing animal impacts on at least one blade (16) of a wind turbine (1) and designed to be mounted in the wind turbine (1), the system comprising: at least one acoustic sensor (21) designed to be arranged inside the blade (16) in order to measure an acoustic wave created by an impact of an animal on the corresponding blade (16) and to emit a raw signal in response to the measurement of the acoustic wave; a signal acquisition module (22) connected to the sensor (21) or to each sensor (21) to acquire the raw signal and to optionally emit a time signal comprising at least one item of information relating to the impact as a function of the acquired raw signal; a module (23) for storing the time signals that is connected to the signal acquisition module (22) in order to store the time signal, the sensor (21) being a microphone designed to measure acoustic waves propagating through the air and at least one is arranged inside the blade (16) at its base.

The invention concerns the field of the environment and wind-generated power. The invention more specifically concerns the field of detection of impacts made by flying animals on wind turbine blades and forecasting the consequences of a wind turbine or a wind farm installation on flying fauna.

A wind turbine is a device which utilises wind energy.

Today the general opinion in industrialised countries, and increasingly in other countries, is in favour of the use of renewable energy in order to protect the environment.

In this context, there has been increased interest in wind turbines over the last few years, in particular concerning the production of electricity by wind powered generators. The electricity generated by wind turbines is considered to be “cleaner” than electricity generated by thermal generation plants. The use of wind turbines is considered to involve fewer risks to the environment and health than nuclear power plants.

Nevertheless, the installation of a wind turbine or a wind farm is not entirely without environmental consequences.

The use of wind turbines is responsible for a mortality level amongst flying animals (birds and chiroptera) which is often significant. In particular, some wind farms cause the death of several tens of birds and/or bats per wind turbine, per year. This is due to the fact that during operation wind turbines act as a moving obstacle in the path of these creatures.

Statistical solutions exist for assessing the mortality levels of these animals in wind farms.

One of these solutions involves in situ counting at the base of wind turbines the animal cadavers (with a search frequency of every week or even of several weeks). A proportionality relationship is then established by integrating the rate of disappearance of the cadavers and the number of investigation days, to arrive at an estimate for a given period.

In these known solutions, however, mortality rates are acquired in a highly empirical manner with large uncertainties associated with non-standard protocols, observer bias and bias associated with the surroundings etc., which do not allow a rigorous mathematical approach that can be reproduced from one wind farm to another.

This is demonstrated in the article “Relationships between bats and wind turbines in Pennsylvania and West Virginia”, Edward B. Arnett et al., 2004, in Bat Conservation International. In this article, the authors show that the success rate observers cadaver searching is between 14 and 42%, depending on the observer and on the natural environment being searched.

One aim of the invention is therefore to provide a system for detecting analysing animal impacts on a blade of a wind turbine which enables at least one of the above mentioned drawbacks to be overcome.

To this aim, the invention provides a system for counting and analysing animal impacts on at least one blade of a wind turbine which is designed to be mounted on the wind turbine, the system comprising:
at least one acoustic sensor designed to be arranged inside the blade in order to measure an acoustic wave created by an impact of an animal on the corresponding blade and to emit a raw signal in response to the measurement of the acoustic wave;
a signals acquisition module connected to the sensor or to each sensor in order to acquire the raw signal and to optionally emit a time signal comprising at least one item of information relating to the impact as a function of the acquired raw signal;
a module for storing the time signals which is connected to the signals acquisition module in order to store the time signal;

where the sensor is a microphone designed to measure acoustic waves propagating through the air and at least one is arranged inside the blade at its base.

One advantage of such a system is that it provides a more rigorous understanding of the phenomenon of animal mortality induced by the presence of a wind turbine or of a wind farm and identifies the factors which influence this mortality.

The optional, non-restrictive, features of such a system for detecting and analysing animal impacts on at least one blade of a wind turbine are:
the sensor is selected from amongst: an omnidirectional condenser microphone, an electret cardioid type microphone or a piezoelectric cardioid type microphone;
the signals acquisition module includes in addition a low-pass filter to attenuate or suppress background noise comprising low frequencies below 100 Hz contained in the raw signal and/or a high-pass filter to attenuate or suppress high frequencies contained in the raw signal which corresponds, amongst other things, to hard shock type impacts;
the sensor includes means of fixing to the blade by adhesion, welding, screwing, riveting or any other method of fixing;
the means of fixing are a support comprising an anti-vibration component.

The invention also provides a wind turbine comprising at least one blade, one hub and one mast, characterised in that it includes, in addition, such a system for counting and analysing animal impacts on the blade, with at least one sensor being fixed to the base of the blade, with the signals acquisition module and time signals storage module being positioned either in the hub or in the nacelle or in the mast of the wind turbine.

Finally the invention provides a process for counting and analysing animal impacts on at least one blade of a wind turbine, to be operated with at least one such turbine, which includes the following steps;
the sensor measures at least one acoustic wave created by an animal impact on the blade, and emits a raw signal in response to the measurement of the wave;
the signals acquisition module acquires the raw signal and optionally emits a time signal comprising at least one item of information relating to the impact as a function of the raw signal;
the time signals acquisition module stores the time signal;
the time signal is analysed after recovery by means of a method of statistical analysis.

The optional, non-restrictive, characteristics of such a process for counting and analysing animal impacts on at least one blade of a wind turbine are:
the signals acquisition module emits a time signal when the raw signal reaches and/or exceeds a threshold amplitude and includes at least one characteristic signal of an animal impact on the blade;
the characteristic signal is a pulse signal characterised by a quasi-spontaneous increase in the amplitude followed by a logarithmic/exponential decrease;
the method of analysis, carried out using the information included in the time signal, consists of at least one from: the calculation of a mean, the calculation of a standard deviation, the calculation of a median, X²-type analysis, an analysis of the variance, a factorial analysis of the correspondences and a principal component analysis.

Other features, aims and advantages will become apparent on reading the description which follows, with reference to the drawings given for illustrative and non-restrictive purposes, amongst which

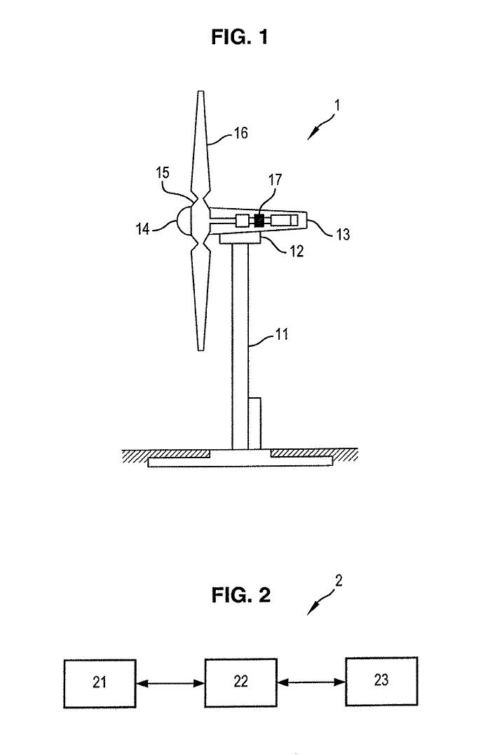

FIG. 1 is a schematic view of a known wind turbine;

FIG. 2 is a schematic view of one possible system for detecting and analysing animal impacts on a blade of a wind turbine according to the invention,

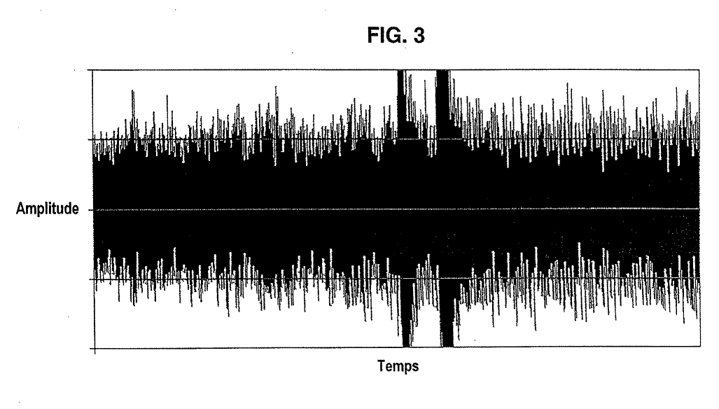

FIG. 3 shows an example of a raw signal obtained by the system in FIG. 2, represented by its amplitude as a function of time;

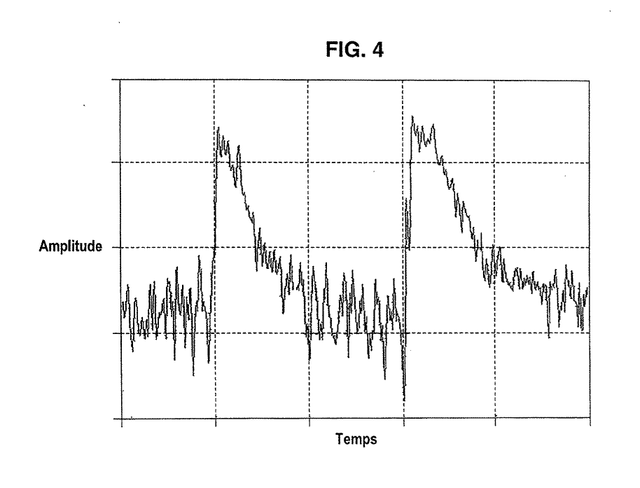

FIG. 4 is an enlargement of a zone in FIG. 3, in which a signal induced by an impact on a blade of a wind turbine appears.

The invention concerns a system 2, schematically illustrated in FIG. 2, for counting and analysing animal impacts on at least one blade 16 of a wind turbine 1 designed to be mounted in the wind turbine 1.

A wind turbine of the wind-powered generator type is illustrated in FIG. 1 and includes a vertical mast 11, a nacelle 13, means of orientation 12 in order to pivot the nacelle 13 around the axis of the mast 11, a hub 14 and a rotor 15 which is firmly attached to at least one blade 16. The number of blades 16 is, for example, three.

The blades 16, which are moved by the wind, cause a shaft to rotate around its axis to generate electric power. A brake 17 is provided on the shaft to prevent the blades from moving, in particular when meteorological conditions are unfavourable or in the event of danger.

The system 2 includes at least one acoustic sensor 21 designed to be arranged inside the blade 16 in order to measure an acoustic wave created by an animal impact on the corresponding blade 16 and to emit a raw signal in response to the measurement of the acoustic blade.

The number of sensors 21 is at least equal to the number of blades 16, with at least one sensor 21 being arranged inside each blade 16.

The sensor 21 is a microphone designed to measure acoustic waves propagating through the air and is arranged inside the blade 16. At least one sensor 21 is arranged at the base of each blade 16.

Measurement of acoustic waves propagated through the air is advantageous in comparison with measurement of solid-propagation acoustic waves, that is, acoustic waves propagated by a solid (for example measurements using Doppler laser or by accelerometer). Solid propagation is highly dependent on the structure and geometry of the blade 16. In addition, the composition of the material used for the construction of the blade 16 makes the solid-phase propagation complex in nature and makes modelling of the propagation non-transferable to all types of blades 16. The measurement of acoustic waves propagated in air enables a more universal treatment of wind turbines.

Also, the use of acoustic waves propagating in solids would require the use of contact sensors to be placed in contact with the internal surfaces, which would represent a certain drawback, since the sensor would have to be adapted to each type of blade.

The arrangement of the sensor 21 at the base of the blade 16 enables better measurement of the acoustic wave created and which is propagated through the blade 16. Since the blade 16 is hollow, it acts as a sounding board and part of the acoustic wave created by the impact is directed towards the base.

The sensor 21 includes means of fixing to the blade 16 by adhesion, welding, screwing, riveting or any other method of fixing.

The sensor 21 is either an omnidirectional type microphone, or an electret cardioid type microphone or a piezoelectric cardioid type microphone.

These means of fixing can be made directly on the sensor 21.

These means of fixing may also be a rigid or jointed support comprising fixing feet which allow the assembly to be fixed by adhesion, welding, screwing, riveting or any other method of fixing. This support is fixed on one side to the sensor 21, by adhesion, welding, screwing, riveting or any other method of fixing, and on the other to the blade 16. The support can include anti-vibration components.

For example, the support is a rigid support fixed firmly to the structure of the existing blade; with the support being equipped with a device enabling it to be mechanically separated and which includes an anti-vibration ring.

The system 2 also includes a signal acquisition module 22 connected to the sensor 21 or to each sensor 21 in order to acquire the raw signal and to optionally emit a time signal comprising at least one item of information relating to the impact as a function of the acquired raw signal.

System 2 in addition includes a time signals storage module 23 connected to the signals acquisition module 22 in order to store the time signal.

The signals acquisition module 22 includes a low-pass filter to attenuate or suppress background noise comprising low frequencies of less than 100 Hz contained in the raw signal.

Alternatively, the low-pass filter is a filter whose decibel response is a function of the frequency, with a gradient of 18 dB/octave up to a cut-off frequency of 100 Hz, with a plateau beyond the 100 Hz cut-off frequency. The frequency position of the cut-off frequency can be adjusted.

The background noise is generated, amongst other things, by the operation of the wind turbine. It may be relatively intense (the amplitude of the corresponding wave may be as large as the amplitude of a wave created by an impact).

The signals acquisition module 22 may also include a high-pass filter to attenuate or suppress high frequencies contained in the raw signal which correspond, amongst other things, to hard-shock type impacts.

Hard-shock type impacts are characterised by the emission of a high frequency wave. These impacts may be caused, in a non-restrictive manner, by stones, pebbles, branches of trees, hailstones etc.

Unlike hard type impacts, impacts caused by animals such as birds or bats are soft-type and are characterised by the emission of a low-frequency wave. The frequencies that occur in such a wave fall within a much wider range than the characteristic low frequencies of the background noise. The background noise is characterised by very low frequencies.

The signals acquisition module 22 and the time signals storage module 23 may be positioned, separately, either in the hub 14, or in the nacelle, 13, or in the mast 11 of the wind turbine 1.

A metal cradle is provided for installing the system 2 in a wind turbine 1. The cradle may include an acquisition computer and units associated with this function. The cradle dimensions may be 40×40×10 cm (length×height×depth). The dimensions may also be smaller.

One advantage of the system 2 is the independence of the measurements made by each of the sensors 21 due to their positioning and to their nature. That is, each sensor 21 only measures impacts occasioned by the blade 16 inside which it is fixed.

Another advantage of the system 2 is the independence of the measurements made by each of the sensors 21 relative to the acoustic waves which may originate in the environment outside the wind turbine 1. That is, the sensors 21 only measure the acoustic waves which relate to the wind turbine 1, for example its operation, stresses on its structure etc. An acoustic wave created by an element outside and away from the wind turbine will not be measured by the sensors 21.

The invention also concerns a process for counting and analysing animal impacts on at least one blade 16 of the wind turbine 1 equipped with the system 2.

This process includes the following steps:
the sensor 21 measures the acoustic wave created by the impact of an animal on the blade 16, and emits a raw signal in response to the measurement of the wave;
the signals acquisition module 22 acquires the raw signal and optionally emits a time signal comprising at least one item of information relating to the impact as a function of the raw signal, the general shape of which is illustrated in FIG. 3;
the time signals storage module 23 stores the time signal;
the time signal is analysed after retrieving using a method of statistical analysis.

FIG. 3 comes from a simulation of soft-type impacts caused by relatively flexible thermoplastic balls with a diameter of about 17 mm and with a weight of about 2.6 g and a hardness of 35 SHORE.

Since these balls are of low hardness they cause a soft-type impact on the blade 16.

The weight of the balls is less than the weights of species most commonly affected by wind turbines, which are songbirds and bats. If the sensor 21 can measure the waves created by such balls then it can also measure the waves created by these song-birds and bats. For example, a robin (Erithacus rubecula) weighs between about 16 g and 22 g and a wren (Nannus troglodytes), one of the smallest European birds, about 8 g. Equally, a common pipistrelle bat (Pipistrellus pipistrellus), the smallest European bat, only weighs between about 3.5 g and 8 g.

The signals acquisition module 22 emits a time signal when the raw signal reaches and/or exceeds a threshold amplitude and includes at least one characteristic signal of an animal impact on the blade;

The information relating to an impact may be the time of the impact, the day of the impact, identification of the wind turbine, identification of the blade suffering an impact, wind speed, wind direction etc.

The characteristic signal is a pulse symbol characterised by a quasi-spontaneous increase in amplitude followed by a logarithmic/exponential decrease as illustrated in FIG. 4, which comes from the same simulation as that used to obtain the raw signal in FIG. 3.

The method of analysis, carried out using the item or items of information included in the time signal, consists of at least one of: the calculation of a mean, the calculation of a standard deviation, the calculation of a median, a X²-type analysis, an analysis of the variance, a factorial analysis of the correspondences and a principal component analysis. The analysis may be carried out in an automated manner by suitable equipment.

The purpose of the method of analysis is partly to identify factors which are relevant to the study of the mortality of birds and/or bats and to determine correlations between the various parameters and/or factors in order to predict the impact of a future wind turbine and/or a wind farm to be installed.

One of the factors may, for example, be the type of countryside, the structure of the wind farm (in line or in clusters), the seasonal cycles, the daily cycle etc.

The connection between the sensor 21 or sensors 21 and the signals acquisition module 22 may be made by a connector comb, known to those working in this field, and which are used to connect two elements which rotate in relation to one another.

This connection may also be made using a wireless connection.

The connection between the signals acquisition module 22 and the time signals storage module 23 may be by wire or wireless.

The emission of time signals by the signals acquisition module 22 to the time signals storage module may be achieved using signal packets. That is, in a discontinuous manner.

The signals acquisition module 22 may be analogue.

For example, the signals acquisition module 22 may be a CompactRIO type analogue system from National Instruments or 01 dB.

The time signals storage module 23 may be a server, a data base, a hard disk, a diskette, a CD-ROM a DVD or any other means of data storage.

These data may be recovered either by collection from the time signals storage module 23 either remotely, using a chosen frequency, by modem or any other remote communication system.

The system 2 may be powered by batteries or directly from sources available in the wind turbine 1.

One advantage of this process is that the impacts of animals on blades 16 of a wind turbine 1 can be analysed, on the one hand, in order to identify the factors with which these impacts correlate and on the other hand to adapt the operation of wind farms and the arrangement of wind turbines inside these wind farms in order to reduce the number of impacts.

Another advantage of this process is that it provides a predictive approach to impacts in projected wind farms.

The results obtained may, for example, be the percentage chance P of having a mortality of level X over a year or over a period of the year.

The description used a wind turbine of the wind-powered generator type. The invention, however, is not restricted to this type of wind turbine. Those working in this field will be able to adapt the invention to any type of wind turbine comprising blades which can act as a wave guide, for example a Darrieus rotor type wind turbine.

Throughout the description the terms “a wave” and “a signal” must be understood to include both singular and plural.

1. A system for counting and analyzing animal impacts on at least one blade of a wind turbine and designed to be mounted in the wind turbine, where the system comprises:
at least one acoustic sensor designed to be arranged inside the blade in order to measure an acoustic wave created by an animal impact on the corresponding blade and to emit a raw signal in response to the measurement of the acoustic wave;
a signals acquisition module connected to the sensor or to each sensor in order to acquire the raw signal and to optionally emit a time signal comprising at least one item of information relating to the impact as a function of the acquired raw signal;
a module for storing the time signals that is connected to the signals acquisitions module in order to store the time signal;
wherein the sensor is a microphone designed to measure acoustic waves propagated through the air and at least one is arranged inside the blade at its base.

2. The system according to claim 1, wherein the sensor is selected from amongst: an omnidirectional condenser type microphone, an electret cardioid type microphone or a piezoelectric cardioid type microphone.

3. The system according to claim 1, wherein the signals acquisition module in addition includes a low-pass filter to attenuate or suppress background noise comprising low frequencies of less than 100 Hz contained in the raw signal and/or a high-pass filter to attenuate or suppress high frequencies contained in the raw signal which correspond, amongst other things, to hard-shock type impacts.

4. The system according to claim 1, wherein the blade is affixed to the sensor by adhesion, welding, screwing, riveting or any other method of fixing.

5. The system according to claim 4, wherein said other method of fixing is a support comprising an anti-vibration component.

6. A sind turbine comprising at least one blade, one hub and one mast, wherein the wind turbine further includes a system for counting and analyzing animal impacts on the blade according claim 1,
wherein at least one sensor is fixed at the base of the blade,
wherein the signals acquisition module and the time signals storage module are positioned either in the hub or in the nacelle or in the mast of the wind turbine.

7. A method for counting and analyzing animal impacts on at least one blade of a wind turbine to be implemented with at least one wind turbine according to claim 6, comprising the following steps:
measuring, with the sensor, at least one acoustic wave created by an animal impact on the blade and emitting, with a sensor, a raw signal in response to the measurement of the wave;
acquiring, with the signals acquisition module, the raw signal and optionally emitting, with the signals acquisition module, a time signal comprising at least one item of information relating to the impact as a function of the raw signal;
storing, with the time signals storage module, the time signal;
analyzing the time signal after retrieving using a statistical analysis method.

8. The method of claim 7, wherein the signal acquisition module emits a time signal when the raw signal reaches and/or exceeds a threshold amplitude and includes at least one characteristic signal of an animal impact on the blade.

9. The method of claim 8, wherein the characteristic signal is a pulse signal characterised by a quasi-spontaneous increase in amplitude followed by a logarithmic/exponential decrease.

10. The method of of claim 7, wherein the method of analysis, carried out using the information included in the time signal, consists of at least one of: the calculation of a mean, the calculation of a standard deviation, the calculation of a median, a X²-type analysis, an analysis of the variance, a factorial analysis of the correspondences and a principal component analysis.
